(19) United States
(12) Patent Application Publication
(10) Pub. No.: US 2021/0192433 A1
(43) Pub. Date: Jun. 24, 2021

(54) COMMODITY EXHIBITION MANAGEMENT METHOD, MANAGEMENT SERVER, CLIENT AND SYSTEM

(71) Applicants: BOE Intelligent IoT Technology Co., LTD., Beijing (CN); BOE TECHNOLOGY GROUP CO., LTD., Beijing (CN)

(72) Inventors: Xu JI, Beijing (CN); Fengming HU, Beijing (CN)

(21) Appl. No.: 17/012,888

(22) Filed: Sep. 4, 2020

(30) Foreign Application Priority Data
Dec. 19, 2019 (CN) 201911317706.X

(51) Int. Cl. G06Q 10/08; G06Q 10/06; G06Q 30/02; G06F 16/23

(52) U.S. Cl. CPC G06Q 10/087; G06Q 10/063114; G06Q 10/06316; G06F 16/2358; G06Q 30/0201; G06Q 30/0282; G06Q 10/0637

(57) ABSTRACT

The present disclosure provides a commodity exhibition management method, a management server, a client and a commodity exhibition management system. The commodity exhibition management method is executed by the management server, and the method includes: generating a commodity exhibition task and transmitting the commodity exhibition task to a target store, wherein the commodity exhibition task instructs to place a commodity at a placement position in an electronic shelf of the target store, and an electronic shelf label to be bound to a commodity placed at the placement position in the electronic shelf is provided at the placement position; and determining a completion degree of the commodity exhibition task executed by the target store by monitoring a change of information of binding between the commodity and the electronic shelf label in the target store.

### CROSS-REFERENCE TO RELATED APPLICATION(S)

This application claims priority to the Chinese Patent Application No. 201911317706.X, filed on Dec. 19, 2019, which is incorporated herein by reference in its entirety.

### TECHNICAL FIELD

The present disclosure relates to the technical field of intelligent device management, and more particularly, to a commodity exhibition management method and system.

### BACKGROUND

Commodity exhibition management plays an important role in retail businesses, and exhibition positions are directly related to sales of commodities. Usually, headquarters uniformly determine exhibition positions of the commodities on shelves and distribute the exhibition positions to various stores, and employees in the stores place the commodities on the respective shelves according to an exhibition plan. Generally, it is difficult to supervise the exhibition positions of the commodities in the stores, and the exhibition accuracy and the exhibition efficiency of the commodities are low.

### SUMMARY

In a first aspect, the present disclosure provides a commodity exhibition management method executed by a management server, the method comprising:

generating a commodity exhibition task and transmitting the commodity exhibition task to a target store, wherein the commodity exhibition task instructs to place a commodity at a placement position in an electronic shelf of the target store, and wherein at the placement position in the electronic shelf, an electronic shelf label is provided in order to be bound to a commodity placed at the placement position; and

determining a completion degree of the commodity exhibition task executed by the target store by monitoring a change of information of binding between the commodity and the electronic shelf label in the target store.

In an example, the completion degree of the commodity exhibition task comprises at least one of a completion ratio of the commodity exhibition task or a time consumed to complete the commodity exhibition task.

In an example, determining the completion degree of the commodity exhibition task executed by the target store according to the change of the binding information comprises:

performing statistics on a ratio of a number of commodities in the commodity exhibition task for which information of binding with an electronic shelf label has changed within a first specified time period relative to a number of commodities in the commodity exhibition task; and

determining the ratio as the completion degree of the commodity exhibition task.

In an example, determining the completion degree of the commodity exhibition task executed by the target store according to the change of the binding information comprises:

performing statistics on the time used to complete the change of information of binding between all commodities in the commodity exhibition task and the electronic shelf labels; and

determining the time used to complete the change of information of binding between all the commodities in the commodity exhibition task and the electronic shelf labels as the completion degree of the commodity exhibition task.

In an example, monitoring a change of information of binding between the commodity and the electronic shelf label in the target store comprises:

monitoring a change of a number of bindings between commodities in the commodity exhibition task and electronic shelf labels in the target store.

In an example, generating a commodity exhibition task and transmitting the commodity exhibition task to the target store comprises:

acquiring a commodity exhibition map of the target store;

determining commodity exhibition information of the target store according to the commodity exhibition map, wherein the commodity exhibition information comprises a layout of the electronic shelves in the target store, placement positions of commodities on the electronic shelves, and associations between the commodities and the electronic shelf labels;

generating the commodity exhibition task based on the commodity exhibition information; and

issuing the commodity exhibition task to a client of the target store, so that the client performs the commodity exhibition task by changing the information of binding between the at least one commodity and the electronic shelf labels.

In an example, the management server comprises a main management server and a branch management server, and generating a commodity exhibition task and transmitting the commodity exhibition task to the target store comprises:

generating, by the main management server, the commodity exhibition task and transmitting the commodity exhibition task to the branch management server, and receiving, by the branch management server, the commodity exhibition task and transmitting the commodity exhibition task to at least one client in the target store.

In an example, there are at least two target stores, and the method further comprises:

ranking completion degrees of the commodity exhibition tasks executed by the at least two target stores; and

transmitting a result of the ranking to all the target stores.

In an example, there are a plurality of commodity exhibition tasks, and the method further comprises:

acquiring sales situation of a specified commodity commonly contained in the plurality of commodity exhibition tasks within a second specified time period after the plurality of commodity exhibition tasks are executed;

determining a placement position where the sales situation meets a preset condition as a specified placement position of the specified commodity; and

setting the specified placement positions as placement positions of the specified commodity.

In an example, the method further comprises: determining information of associated commodities to be placed around the specified commodities according to the specified placement positions.

In an example, the method further comprises:

acquiring information of best-selling commodities in the target store within a third specified time period; and

analyzing the information of the best-selling commodities to acquire high-value shelf information which comprises at least one of positions of electronic shelves where the best-selling commodities are located, placement positions of the best-selling commodities in the electronic shelves, or information of combination of commodities in the electronic shelves where the best-selling commodities are located.

In an example, the method further comprises:

assigning an execution level to the commodity exhibition task according to an importance degree of the commodity exhibition task, wherein the execution level comprises at least a first level and a second level, a commodity exhibition task at the first level is a task which must be completed, and a commodity exhibition task at the second level is a task which is optionally completed.

In a second aspect, the present disclosure provides a commodity exhibition management method executed by a client, the method comprising:

receiving a commodity exhibition task transmitted by a management server, wherein the commodity exhibition task instructs to place a commodity at at a placement position in an electronic shelf of the target store, and at the placement position in the electronic shelf, an electronic shelf label is provided in order to be bound to a commodity placed at the placement position; and

executing the commodity exhibition task by changing information of binding between the commodity and an electronic shelf label associated therewith.

In an example, executing the commodity exhibition task by changing information of binding between the commodity and an electronic shelf label associated therewith comprises:

extracting a commodity exhibition instruction from the received commodity exhibition task, wherein the commodity exhibition instruction comprises a layout of the electronic shelf of the target store, placement position of the commodity on the electronic shelf, and association between the commodity and electronic shelf label;

providing a user with the commodity exhibition instruction, so that the user places the commodity at the placement position on the electronic shelf according to the commodity exhibition instruction; and

changing the information of binding between the commodity and the electronic shelf label associated therewith in response to the user's placement of the commodity, and transmitting change data of the information of binding to the management server.

In a third aspect, the present disclosure further provides a management server, comprising a memory and a processor, wherein the memory has stored therein instructions which, when executed by the processor, cause the processor to execute the method described above.

In a fourth aspect, the present disclosure further provides a client, comprising a memory and a processor, wherein the memory has stored therein instructions which, when executed by the processor, cause the processor to execute the method described above.

In a fifth aspect, the present disclosure further provides a commodity exhibition management system, comprising:

a management server configured to generate a commodity exhibition task and transmitting the commodity exhibition task to a target store, wherein the commodity exhibition task instructs to place a commodity at a placement position in an electronic shelf of the target store, and wherein at the placement position in the electronic shelf, an electronic shelf label is provided in order to be bound to a commodity placed at the placement position; and determine a completion degree of the commodity exhibition task executed by the target store by monitoring a change of information of binding between the commodity and electronic shelf label in the target store; and

a client located in the target store and in communication with the management server, and configured to receive the commodity exhibition task from the management server, and execute the commodity exhibition task by changing information of binding between the commodity and an electronic shelf label associated therewith.

In an example, the system further comprises:

a sensor located in the electronic shelf of the target store, and configured to acquire sales information of commodities placed in the electronic shelf and feed the sales information back to the management server.

In a sixth aspect, the present disclosure further provides a storage medium having stored therein a computer program which, when executed by a computer, causes the computer to execute the commodity exhibition management method according to the first aspect.

In a seventh aspect, the present disclosure further provides a storage medium having stored therein a computer program which, when executed by a computer, causes the computer to execute the commodity exhibition management method according to the second aspect.

The above description is only an overview of the technical solutions according to the present disclosure. In order to understand the technical means of the present disclosure more clearly, the technical solutions may be implemented in accordance with the content of the specification, and in order to make the above and other purposes, features and advantages of the present disclosure more obvious and understandable, specific embodiments of the present disclosure will be particularly described.

### BRIEF DESCRIPTION OF THE DRAWINGS

By reading the detailed description of the following embodiments, various other advantages and benefits will become clear to those of ordinary skill in the art. The accompanying drawings are only used for the purpose of illustrating the embodiments, and are not considered as a limitation to the present disclosure. Also, throughout the accompanying drawings, the same reference signs are used to denote the same components. In the accompanying drawings:

FIG. 1 illustrates a flowchart of a commodity exhibition management method for a management server according to an embodiment of the present disclosure;

FIG. 2 illustrates a flowchart of another commodity exhibition management method for a management server according to an embodiment of the present disclosure;

FIG. 3 illustrates a flowchart of a commodity exhibition management method for a client according to an embodiment of the present disclosure;

FIG. 4 illustrates a block diagram of a management server according to an embodiment of the present disclosure;

FIG. 5 illustrates a block diagram of a client according to an embodiment of the present disclosure;

FIG. 6 illustrates a schematic structural diagram of a commodity exhibition management system according to an embodiment of the present disclosure; and

FIG. 7 illustrates a schematic structural diagram of another commodity exhibition management system according to an embodiment of the present disclosure.

### DETAILED DESCRIPTION

Hereinafter, exemplary embodiments of the present disclosure will be described in more detail with reference to the accompanying drawings. Although the exemplary embodiments of the present disclosure are shown in the accompanying drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

The present disclosure provides a commodity exhibition management method and system. A management server transmits a generated commodity exhibition task to a target store, and then the target store adjusts exhibition of commodities and binds the commodities to electronic labels according to a change of information of placement positions of the commodities on shelves in the commodity exhibition task through a client. When the operations of adjusting the exhibition of the commodities and binding the commodities to the electronic labels are completed through the client, the information of the binding between the commodities and the electronic shelf labels may be fed back to the management server, so as to automatically perform statistics on a completion situation of the commodity exhibition task. With this system, the exhibition of the commodities is managed, which may realize the monitoring of the commodity exhibition task, reduce or decrease a cost of manual inspection, and improve the management efficiency of inter-regional supervision of chain supermarkets.

The embodiments of the present disclosure provide a commodity exhibition management method, which is applied to a management server, wherein the management server may be used to manage a certain target store or may also be used to manage a plurality of target stores. In the commodity exhibition management system according to the present disclosure, the management server may receive exhibition data of commodities of which placement positions are changed, and then distribute the data to a client in the target store in a form of commodity exhibition task, so that employees in the store may place the commodities. The management server according to the present disclosure may be a device which may meet functional requirements of the present disclosure, for example, a server, a desktop host computer, a cloud server, a portable laptop, a mobile phone, etc. The target store according to the present disclosure may be a store which has demands for commodity presentation, for example, a shopping mall, a supermarket, an exhibition hall, etc., and in some embodiments, may be one of chain stores comprising a main store and branch stores.

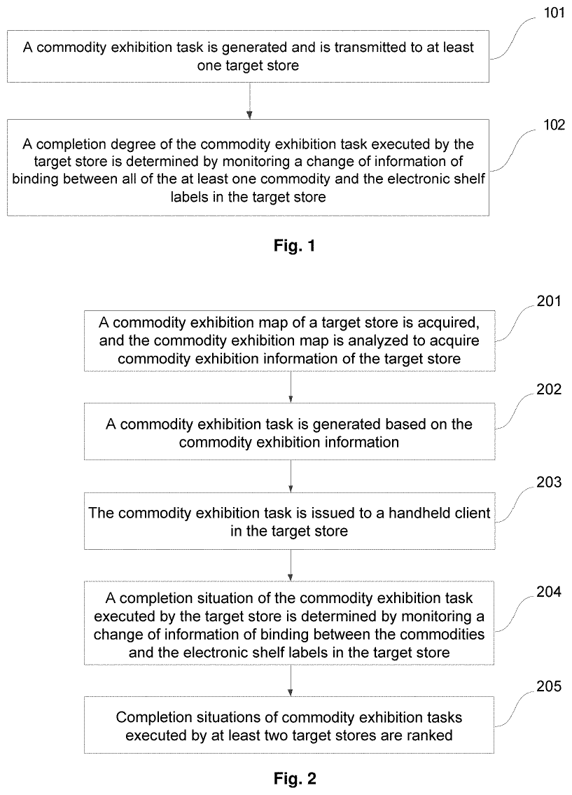

Hereinafter, a commodity exhibition method executed by a management server according to an embodiment of the present disclosure will be described with reference to FIGS. 1 and 2.

FIG. 1 illustrates a flowchart of a commodity exhibition management method for a management server according to an embodiment of the present disclosure.

In step 101, a commodity exhibition task is generated and is transmitted to at least one target store.

At least one electronic shelf may be provided in the target store, and each electronic shelf may have at least one placement position provided thereon, for example, there are a plurality of layers provided on the electronic shelf, and the placement positions are characterized by positions of the layers. Of course, the embodiments of the present disclosure are not limited thereto, and the placement positions may also be characterized by other parameters, for example, a plurality of columns may be provided in each layer, and the placement positions may be characterized by the positions of the layers and positions of the columns in the respective layers. An electronic shelf label may be provided at each placement position on the electronic shelf, and the electronic shelf label is used to be bound to a commodity which is placed at the placement position. For example, an electronic shelf label B1C1 is provided on a layer C1 of an electronic shelf B1, and an electronic shelf label B2C2 is provided on a layer C2 of an electronic shelf B2.

A commodity exhibition task may be generated according to commodity exhibition data, and the commodity exhibition task may instruct to place at least one commodity at at least one placement position in at least one electronic shelf of the target store. For example, the commodity exhibition task may comprise a change of information of placement positions of at least one commodity in the target store on shelves, that is, data of a change of exhibition positions of the commodities is recorded in the commodity exhibition task.

In some embodiments, the commodity exhibition task may instruct to place a commodity A1 on the layer C1 of the electronic shelf B1 and place a commodity A2 on the layer C2 of the electronic shelf B2. When an employee in the target store places the commodity A1 on the layer C1 of the electronic shelf B1, the employee may use a client (for example, a handheld terminal) to bind the commodity A1 to the electronic shelf label B1C1; and similarly, when the employee places the commodity A2 on the layer C2 of the electronic shelf B2, the employee may bind the commodity B2 to the electronic shelf label B2C2. The client may use a binding relationship between the commodity A1 and the electronic shelf label B1C1 as binding information A1B1C1, and may use a binding relationship between the commodity A2 and the electronic shelf label B2C2 as binding information A2B2C2, and may provide the binding information A1B1C1 and A2B2C2 to the management server.

In some other embodiments, the commodity exhibition task may instruct to transfer the commodity A1 from the layer C1 of the shelf B1 where the commodity A1 is placed to the layer C2 of the shelf B2; or transfer the commodity A1 from the layer C1 of the shelf B1 where the commodity A1 is placed to the layer C2 of the shelf B1; or remove the commodity A1 from the layer C1 of the shelf B1 where the commodity A1 is placed and instead place the commodity A2 on the layer C1 of the shelf B1; or place the commodity A1 on the layer C1 of the shelf B1 which is not occupied etc. When commodities are added, substituted or removed in the electronic shelves, the information of the binding between the electronic shelf labels and the commodities in the electronic shelves may change.

The so-called commodity refers to a plurality of products having the same name. For example, the commodity A1 may refer to instant noodles having a name of “XXX beef noodles”. The so-called placing the commodity A1 on the layer C1 of the electronic shelf B1 may refer to placing one or more packs of XXX beef noodles on the layer C1 of the electronic shelf B1. The commodity exhibition task does not limit a number of packs of XXX beef noodles to be placed. Of course, the embodiments of the present disclosure are not limited thereto. In some embodiments, the so-called commodity may refer to one product. For example, the commodity A1 may refer to a pack of XXX beef noodles, and the commodity exhibition task may specify placing ten packs of XXX beef noodles on the layer C1 of the electronic shelf B1.

After the commodity exhibition task is generated, the commodity exhibition task may be transmitted to the target store. For example, the management server generates a commodity exhibition task and transmits the commodity exhibition task to the target store. In some embodiments, there are a plurality of target stores, comprising a main store and a plurality of branch stores. The commodity exhibition task is formulated for a main management server of the main store and is transmitted to at least one branch store. The commodity exhibition task may be directly transmitted to a client in the branch store; or may be firstly transmitted to a branch management server for the branch store, and is then transmitted to the client in the store branch through the branch management server. The client may be a PDA having a function of unbinding and/or binding electronic shelf labels through NFC etc. After an employee in the branch store who manages commodities has changed the placement of the commodities, the employee may use the client to change information of binding between electronic shelf labels (comprising at least names and prices of the commodities) for identifying the commodities and the commodities to complete the commodity exhibition task.

It should be illustrated that the generated commodity exhibition task may be transmitted to a specified target store, or may also be transmitted to all target stores, that is, when the commodity exhibition task is generated, the commodity exhibition task has a correspondence relationship with the target store(s) to which it is transmitted.

In step 102, a completion degree (hereinafter also referred to as a completion situation) of the commodity exhibition task executed by the target store is determined by monitoring a change of information of binding between each of the at least one commodity and the electronic shelf label in the target store.

The target store adjusts placement positions of the shelves and positions of the commodities in the store according to the commodity exhibition task, binds the commodities to the electronic shelf labels, and feeds the binding information back to the management server, and the management server performs statistics on a completion situation of the commodity exhibition task executed by each target store according to the change of the binding information.

It may be seen that the management server according to the embodiment of the present disclosure determines the completion situation of the commodity exhibition task by performing statistics on the change of the information of the binding between the commodities and the electronic shelf labels in the target store. Since the electronic shelf labels may accurately reflect the positions of the shelves in the store where the electronic shelf labels are located, it may be determined through the binding information whether the target store adjusts the exhibition positions of the commodities according to the requirements of the commodity exhibition task, which reduces the labor management cost.

FIG. 2 illustrates a flowchart of another commodity exhibition management method for a management server according to an embodiment of the present disclosure.

In step 201, a commodity exhibition map of a target store is acquired, and the commodity exhibition map is analyzed to acquire commodity exhibition information of the target store.

Here, the commodity exhibition map is drawn by using graphics software according to actual placement positions of shelves in the target store and a structure of the shelves, and a position of each shelf, a number of layers etc. are marked in the map. The commodity exhibition map may specifically be an interactive graph, and a shelf grid map corresponding to a shelf may be further presented by touching the shelf in the map. The shelf grid map records information of commodities and information of corresponding electronic shelf labels.

The commodity exhibition information obtained by analyzing the commodity exhibition map comprises layout information of the shelves in the target store, exhibition information of the commodities on the shelves, and information of binding between the commodities and electronic shelf labels to which the commodities are bound. For example, the commodity exhibition information comprises a layout of a plurality of electronic shelves in the target store, placement positions of various commodities on each electronic shelf, and associations between the various commodities and the electronic shelf labels.

In step 202, a commodity exhibition task is generated based on the commodity exhibition information.

In this step, the commodity exhibition information refers to the information obtained by analysis in step 201, and is used to generate the commodity exhibition task. In addition to the commodity exhibition information, information of commodities for which exhibition positions need to be adjusted and corresponding adjustment information may further be acquired, and the information is generally set manually as required (for example, according to sales targets, sales contracts with manufacturers, etc.), or is obtained based on statistical analysis of historical sales data.

In step 203, the commodity exhibition task is issued to a client (for example, a handheld terminal) in the target store.

In this step, the issuing operation may be executed by forwarding the commodity exhibition task through a server provided in the target store, or may be executed by directly issuing the commodity exhibition task to the client which belongs to the target store through a wireless network. An employee who manages the commodities in the target store may obtain the commodity exhibition task through the client, so as to change the information of the binding between the commodities and the electronic shelf labels in the task to complete the commodity exhibition task.

It should be illustrated that, in the embodiments of the present disclosure, the management server is not limited to a certain server, and may also be a general term for a plurality of servers, for example, in a management system of chain supermarkets, according to a hierarchical relationship in the system, the management server comprises a main management server and branch management servers provided in various target stores. Here, the main management server is used to generate a commodity exhibition task and transmit the commodity exhibition task to at least one branch management server, and after the branch management server receives the commodity exhibition task, the branch management server transmits the commodity exhibition task to at least one client in the target store.

In step 204, a completion degree of the commodity exhibition task executed by the target store is determined by monitoring a change of information of binding between the commodities and the electronic shelf labels in the target store.

In this step, monitoring the change of the information of the binding between the commodities and the corresponding electronic shelf labels in the target store comprises, but not limited to, monitoring a change of binding processes between the commodities and the corresponding electronic shelf labels in the target store, so as to facilitate quantitative evaluation of the completion situation.

In this step, the completion situation of the commodity exhibition task specifically comprises a completion ratio of the commodity exhibition task and/or a time consumed to complete the commodity exhibition task.

Here, the completion ratio of the commodity exhibition task is to evaluate a number of tasks completed. Generally, there will be position adjustment information of a plurality of commodities in the commodity exhibition task, and each time a position of a commodity is adjusted completely, the completion ratio of the commodity exhibition task may change. The time consumed to complete the commodity exhibition task is to evaluate a speed of completion of the task. These indexes may be used to perform quantitative evaluation on the completion situation of the commodity exhibition task.

For example, statistics may be performed on a ratio of a number of commodities in the commodity exhibition task for which information of binding with a corresponding electronic label has changed within a specified time period (a first specified time period) relative to a number of commodities in the commodity exhibition task, and the ratio may be determined as the completion situation of the commodity exhibition task. In some embodiments, statistics may be performed on the time used to complete the change of the information of the binding between all the commodities and the electronic shelf labels in the commodity exhibition task, for example, a time period from a time when the above ratio becomes greater than 0 to a time when the ratio becomes 100% is determined as the completion situation of the commodity exhibition task, that is, the time consumed to complete the commodity exhibition task.

In step 205, completion degrees of commodity exhibition tasks executed by at least two target stores are ranked.

When there are two or more target stores, the completion situation may be used as an evaluation index of performance management, and degrees of execution of the commodity exhibition tasks by the target stores may be determined by ranking the completion degrees, so as to reflect a work attitude of employees in the target stores.

Further, in order to promote the enthusiasm of the target stores, a ranking result may further be transmitted to all the target stores, and a rank of a target store which receives the ranking result may be highlighted.

Further, on the basis of the embodiment shown in FIG. 2, when there are a plurality of commodity exhibition tasks, the management server may further acquire sales situation of a specified commodity commonly contained in the plurality of commodity exhibition tasks within a second specified time period after the plurality of commodity exhibition tasks are executed; determine a placement position where the sales situation meets a preset condition as a specified placement position of the specified commodity; and set the specified placement position as placement position of the specified commodities. In this way, the management server may perform statistics on information of best exhibition positions of the specified commodities. For example, the management server may compare the sales situations of the commodities within a specified time period (the second specified time period) after the plurality of commodity exhibition tasks are executed, perform statistics on placement positions where sales of the specified commodities meet the preset condition according to the sales situations and determine the placement positions as best exhibition positions. The specified commodities may be commodities for which exhibition positions are changed within a specified time. For example, there are a plurality of tasks for adjusting exhibition positions of cola within a specified time. After an adjustment task is executed each time, corresponding sales situations, for example, daily sales or monthly sales, etc., may be determined through the statistics, and thereby exhibition positions corresponding to the highest sales may be determined as best exhibition positions of the cola by comparison. In addition to a plurality of tasks corresponding to the same commodities at different times in the target store, the plurality of commodity exhibition tasks may also refer to a plurality of tasks corresponding to the same commodities at different exhibition positions at the same time in different target stores.

Based on the best exhibition positions of the commodity obtained by the above statistics, the management server may further determine information of associated commodities which are exhibited around the specified commodities. In other words, in addition to sales positions, sales of a commodity may also be related to other factors, for example, information of associated commodities, an exhibition manner, etc. For example, in addition to exhibition positions, the high sales of cola are also related to commodities which are exhibited around the cola, for example, other drinks, snacks, etc., and may also be related to an exhibition manner thereof, for example, a manner of exhibition in a freezer etc. By determining the information of the associated commodities which are exhibited around the specified commodities, it is possible to analyze ways which are beneficial to increase sales when the commodities are exhibited in a multi-dimensional manner, thereby providing data support for generation of commodity exhibition tasks in the future.

Further, the embodiments of the present disclosure may further analyze high-value shelf information based on the statistics of the commodity exhibition data. The high-value shelf information comprises at least one of positions of electronic shelves where best-selling commodities are located, placement positions of the best-selling commodities in the electronic shelves, or information of commodity combination in the electronic shelves where the best-selling commodities are located. For example, data of best-selling commodities in the target store is acquired within a specified time period (a third specified time period), and the data of the best-selling commodities is analyzed to acquire high-value shelf information, wherein the data of the best-selling commodities comprises information such as exhibition positions of these commodities, combination with surrounding commodities etc. That is, the determination of the exhibition of the commodities in the specified shelves may facilitate improving the sales. The high-value shelf information comprises information of positions of the shelves and information of commodity combination in the shelves.

In addition, when there are too many commodity exhibition tasks, or there are a large number of commodities in the commodity exhibition task, the completion situation of the commodity exhibition task(s) may easily be unsatisfactory. In practical applications, the commodity exhibition tasks or the commodities in the task do not need to be fully executed by an employee who manages the commodities. For example, there may be a large number of commodities which are suggested to be adjusted in the task, and exhibition positions of these commodities may be freely adjusted by the target store. Therefore, in some embodiments, different execution levels may be assigned to the commodity exhibition tasks according to importance degrees thereof, wherein the commodity exhibition tasks at least comprise tasks which must be completed (which belongs to a first level) and tasks which are optionally completed (which belongs to a second level), wherein the tasks which must be completed refer to tasks which need to be strictly executed by an employee who manages the commodities, and these tasks are used for performing statistics on the completion situations; and the tasks which are optionally completed refer to tasks corresponding to the commodities which are suggested to be adjusted, and the execution of these tasks does not influence the statistics of the completion situations.

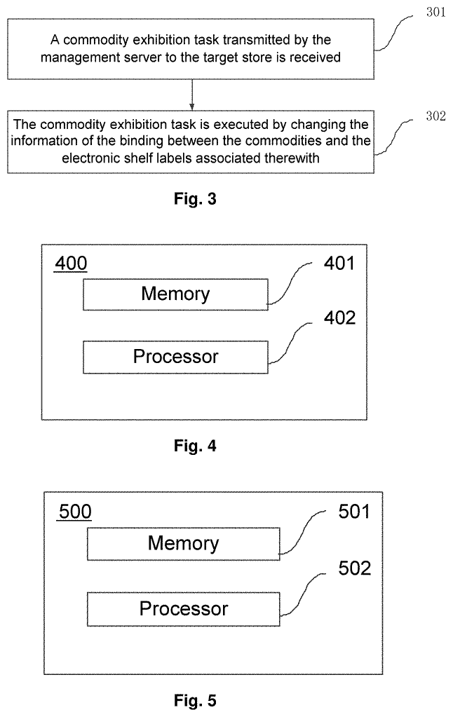

In correspondence to the commodity exhibition management method executed by the management server, the embodiments of the present disclosure further provide a commodity exhibition management method applied to a client of a target store, which will be described below with reference to FIG. 3.

In step 301, a commodity exhibition task transmitted by the management server to the target store is received.

Here, the commodity exhibition task comprises a change of information of placement positions of at least one commodity in the target store on shelves.

For example, the commodity exhibition task is analyzed to obtain information of placement positions of the commodities on the shelves, that is, a commodity exhibition instruction. Here, for new commodities, the instruction is to specify positions where the commodities need to be placed, and for commodities which need to be adjusted, the instruction comprises positions where the commodities are currently placed and new positions where the commodities need to be placed.

When the commodity exhibition information is presented on the client, the commodity exhibition information may be presented in a commodity exhibition map according to the exhibition information of the commodities. The commodity exhibition map may be an interactive graph on which a layout of the shelves of the target store is displayed, and a shelf grid map corresponding to a shelf may be acquired by an employee who manages the commodities touching the shelf in the map, and commodity exhibition information corresponding to the shelf may be displayed. The commodity exhibition information comprises shelf layout information of the target store, exhibition information of the commodities on the shelves, and information of binding between the commodities and electronic shelf labels to which the commodities are bound.

In step 302, the commodity exhibition task is executed by changing the information of the binding between the commodities and the electronic shelf labels associated therewith.

For example, the commodity exhibition task is completed by changing the information of the binding between the commodities and the electronic shelf labels associated therewith according to the presented commodity exhibition information, and change data of the binding information is transmitted to the management server. Here, the binding information is changed by acquiring identification information of the commodities and the electronic shelf labels respectively through a code scanning apparatus in the client, and then performing a binding operation.

When the task is executed, the client may perform the following several operations.

In a first case, the positions of the commodities are adjusted, but a total number of types of the commodities remains unchanged. In this case, the electronic labels in the shelves do not need to be added or deleted, and an employee scans the electronic labels at the positions where the commodities in the task are located to bind the commodities to the electronic labels, and uploads the binding information to the management server.

In a second case, the number of the types of the commodities is decreased, that is, some of the exhibited commodities are removed. In this case, a number of the electronic labels in the shelves may be greater than that of the types of the commodities, and the employee needs to scan electronic labels corresponding to the removed commodities to unbind the commodities from the electronic labels, and remove the electronic labels from the shelves.

In a third case, the number of the types of the commodities is increased. In this case, the employee needs to add electronic labels on the shelves, acquire identifications of the electronic labels, and upload the identifications to the management server to bind the commodities to the electronic labels. This manner is the same as an operation manner for a new store.

The client according to this embodiment may help an employee who manages the commodities to quickly locate the exhibition positions of the commodities through the presented commodity exhibition map, and help the employee to quickly complete the task, thereby improving the execution efficiency of the commodity exhibition task.

The embodiments of the present disclosure further propose a management server, which may be implemented as the management server according to any of the embodiments described above. As shown in FIG. 4, the management server 400 comprises a memory 401 and a processor 402. The memory 401 has stored therein instructions which, when executed by the processor 402, cause the processor 402 to execute the operations executed by the management sever in the commodity exhibition management method described above.

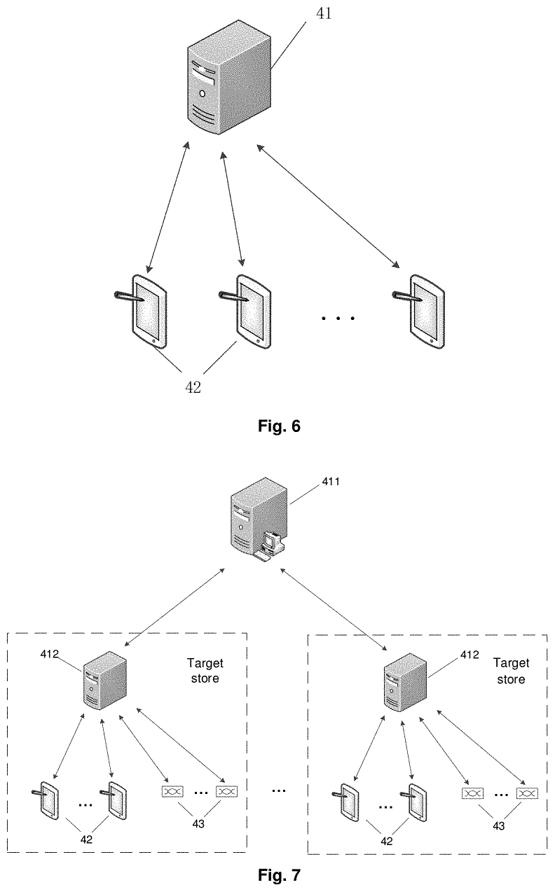

The embodiments of the present disclosure further propose a client, which may be implemented as the client according to any of the embodiments described above. As shown in FIG. 5, the client 500 comprises a memory 501 and a processor 502. The memory has stored therein instructions which, when executed by the processor 502, cause the processor 502 to execute the operations executed by the client in the commodity exhibition management method described above.

The embodiments of the present disclosure further propose a commodity exhibition management system, which comprises the management server according to any of the embodiments described above and the client according to any of the embodiments described above.

As shown in FIG. 6, the commodity exhibition management system comprises a management server 41 and client(s) 42. The management server 41 may generate a commodity exhibition task and transmit the commodity exhibition task to client(s) 42 at least one target store. The commodity exhibition task comprises a change of information of placement positions of at least one commodity in the target store on shelves, so that a target branch store may perform exhibition of the commodities and bind the commodities to electronic labels; monitor a change of the information of the binding between the commodities and corresponding electronic shelf labels in the target store; and determine a completion situation of the commodity exhibition task executed by the target store according to the binding information. The client 42 is located in the target store, may receive the commodity exhibition task, and complete the commodity exhibition task by changing the information of the binding between the commodities and the electronic shelf labels associated therewith.

In some embodiments, as shown in FIG. 7, the management server 41 comprises a main management server 411 and branch management servers 412. The main management server 411 generates the commodity exhibition task and transmits the commodity exhibition task to at least one branch management server 412, and the branch management server 412 receives the commodity exhibition task and transmits the commodity exhibition task to a client 42 belonging to the same target branch store as the branch management server 412. The client 42 may transmit change data of the binding information to the branch management server 412 belonging to the same target branch store as the client 42, the branch management server 412 feeds the change data back to the main management server 411, and the main management server acquires a completion situation of the commodity exhibition task according to the change data.

The main management server 411 may further rank completion situations of the executed commodity exhibition tasks which are fed back by at least two branch management servers 412. Further, the main management server 411 transmits a ranking result to all the target stores.

The management server 41 may monitor the change of the information of the binding between the commodities and the corresponding electronic shelf labels in the target store by monitoring a change of a number of binding processes between the commodities and the corresponding electronic shelf labels in the target store.

The management server 41 may generate a commodity exhibition task by following steps: acquiring, by the management server, a commodity exhibition map of the target store and analyzing the commodity exhibition map to acquire commodity exhibition information of the target store, wherein the commodity exhibition information comprises shelf layout information of the target store, exhibition information of the commodities on the shelves, and information of binding between the commodities and electronic shelf labels to which the commodities are bound; and generating the commodity exhibition task based on the commodity exhibition information.

As shown in FIG. 7, the system may further comprise sensors 43. The sensors 43 are located in the target store, and are used to obtain commodity sales information and feed the commodity sales information back to the management server. Here, the sensors 43 may be provided in the electronic shelves, for example, a sensor 43 may be provided on each layer of each electronic shelf, so as to acquire sales information of commodities placed in the electronic shelf. In some embodiments, the commodity sales information acquired by the sensors 43 in the target store may be fed back to the branch management server 412, and may be uploaded by the branch management server 412 to the main management server 411.

Further, the management server 41 analyzes sales situations of specified commodities within a specified time after a plurality of commodity exhibition tasks are executed according to the sales information, and acquires information of best exhibition positions of the specified commodities, wherein the specified commodities are commodities for which exhibition positions are changed within the specified time.

Further, the management server 41 determines information of associated commodities which are exhibited around the specified commodities according to the best exhibition positions.

Further, the management server 41 acquires data of best-selling commodities of the target store within a specified time period according to the sales information; and analyzes the data of the best-selling commodities to acquire high-value shelf information, wherein the high-value shelf information comprises information of positions of shelves and information of commodity combination in the shelves.

Further, the embodiments of the present disclosure further provide a storage medium having stored therein a computer program which, when executed, control an electronic label where the storage medium is located to execute the commodity exhibition management method described above with reference to FIG. 1 or FIG. 2, or control a control terminal where the storage medium is located to execute the commodity exhibition management method described above with reference to FIG. 3.

In conclusion, the embodiments of the present disclosure provide a commodity exhibition management method and system. A management server transmits a generated commodity exhibition task to a target store, and then the target store adjusts exhibition of commodities and binds the commodities to electronic labels according to a change of information of placement positions of the commodities on shelves in the commodity exhibition task through a client. When the operations of adjusting the exhibition of the commodities and binding the commodities to the electronic labels are completed through the client, the information of the binding between the commodities and the electronic shelf labels may be fed back to the management server, so as to automatically perform statistics on a completion situation of the commodity exhibition task. With this system, the exhibition of the commodities is managed, which may realize the monitoring of the commodity exhibition task, reduce or decrease a cost of manual inspection, and improve the management efficiency of inter-regional supervision of chain supermarkets.

In the above embodiments, different focuses are put on the descriptions of the respective embodiments. Parts which are not described in detail in an embodiment may be known with reference to related descriptions of other embodiments.

It can be understood that related features in the above method and apparatus can be known with reference to each other. In addition, “first”, “second”, etc. in the above embodiments are used to distinguish the embodiments from each other, and do not represent preferred and non-preferred embodiments.

It can be clearly understood by those skilled in the art that for the convenience and brevity of the description, specific operating processes of the system, the apparatus and the unit described above can be known with reference to the corresponding processes in the method embodiment described above, and details thereof will not be described here again.

Algorithms and displays provided here are not inherently related to any particular computer, virtual system or other devices. Various general-purpose systems can also be used with the teachings based thereon. From the above description, the structures required to construct this type of system is obvious. In addition, the present disclosure is not directed to any specific programming language. It should be understood that various programming languages can be used to implement the content of the present disclosure described here, and the above description of a specific language is to disclose the best embodiments of the present disclosure.

In addition, the memory may comprise a non-permanent memory in a computer readable medium, a Random Access Memory (RAM), and/or a non-volatile memory, such as a Read-Only Memory (ROM) or a flash RAM. The memory comprises at least one storage chip.

It will be appreciated by those skilled in the art that embodiments of the present disclosure can be provided as methods, systems, or computer program products. Accordingly, the present disclosure may take a form of a pure hardware embodiment, a pure software embodiment, or a combination of software and hardware aspects. Moreover, the present disclosure may take a form of a computer program product implemented on computer usable storage media (including but not limited to disk storage, CD-ROM, optical memory, etc.) in which computer usable program codes are included.

The present disclosure is described with reference to the flowcharts and/or block diagrams of the methods, devices (systems) and computer program products according to the embodiments of the present disclosure. It should be understood that each flow and/or block in the flowcharts and/or block diagrams as well as a combination of the flows and/or blocks in the flowcharts and/or block diagrams can be implemented by computer program instructions. These computer program instructions can be provided to a processor of a general-purpose computer, a dedicated-purpose computer, an embedded processor, or other programmable data processing devices to generate a machine. Thereby, the instructions executed by the processor of the computer or other programmable data processing devices generate means for implementing functions specified in one or more flows in the flowcharts and/or one or more blocks in the block diagrams.

These computer program instructions can also be stored in a computer readable memory capable of introducing a computer or other programmable data processing devices to operate in a particular mode. Thereby, the instructions stored in the computer readable memory generate an article of manufacture including instruction means for implementing functions specified in one or more flows in the flowcharts and/or one or more blocks in the block diagrams.

These computer program instructions can also be loaded onto a computer or other programmable data processing devices, so as to enable a series of operation steps to be performed on the computer or other programmable devices to generate a computer-implemented process. Thereby, the instructions executed in the computer or other programmable devices provide a step of implementing functions specified in one or more flows in the flowcharts and/or one or more blocks in the block diagrams.

In a typical configuration, a computing device comprises one or more processors (for example, CPUs), input/output interfaces, network interfaces, and memories.

The memory may comprise a non-permanent memory in a computer readable medium, a RAM, and/or a non-volatile memory, such as a ROM or a flash RAM. The memory is an example of the computer readable medium.

The computer readable media, including both permanent and non-persistent media, and removable and non-removable media, may store information through any method or technology. The information may be computer readable instructions, data structures, program modules, or other data. Examples of the computer storage medium comprise, but not limited to, a Phase Change Memory (PRAM), a Static Random Access Memory (SRAM), a Dynamic Random Access Memory (DRAM), other types of RAMs, ROMs, an Electrically Erasable Programmable Read Only Memory (EEPROM), a flash memory or other memory technology, a Compact Disk-Read Only Memory (CD-ROM), a Digital Versatile Disk (DVD) or other optical storage, a cartridge-type magnetic tape, a magnetic tape storage or other magnetic storage devices or any other non-transportable media for storing information which may be accessed by a computing device. As defined herein, the computer readable medium does not comprise transitory media, such as modulated data signals and carriers.

It is also to be illustrated that the terms “comprises” or “comprising” or any other variations are intended to encompass a non-exclusive inclusion, so that a process, method, article, or device, including a series of elements, not only comprises those elements, but also comprises other elements which are not explicitly listed, or elements which are inherent to such a process, method, article, or device. An element defined by a phrase “comprising a . . . ” without further limitation does not exclude the existence of additional identical elements in the process, method, article, or device which comprises the element.

It will be appreciated by those skilled in the art that embodiments of the present disclosure can be provided as methods, systems, or computer program products. Accordingly, the present disclosure may take a form of a pure hardware embodiment, a pure software embodiment, or a combination of software and hardware aspects. Moreover, the present disclosure may take a form of a computer program product implemented on one or more computer usable storage media (including but not limited to disk storage, CD-ROM, optical memory, etc.) in which computer usable program codes are included.

The above description is only the embodiments of the present disclosure and is not intended to limit the present disclosure. Various changes and modifications can be made to the present disclosure by those skilled in the art. Any modifications, equivalents, improvements, etc. made within the spirit and scope of the present disclosure are intended to be included within the scope of the claims of the present application.

1. A commodity exhibition management method executed by a management server, the method comprising:
generating a commodity exhibition task and transmitting the commodity exhibition task to a target store, wherein the commodity exhibition task instructs to place a commodity at a placement position in an electronic shelf of the target store, and wherein at the placement position in the electronic shelf, an electronic shelf label is provided in order to be bound to a commodity placed at the placement position; and
determining a completion degree of the commodity exhibition task executed by the target store by monitoring a change of information of binding between the commodity and the electronic shelf label in the target store.

2. The method according to claim 1, wherein the completion degree of the commodity exhibition task comprises at least one of a completion ratio of the commodity exhibition task or a time consumed to complete the commodity exhibition task.

3. The method according to claim 2, wherein determining the completion degree of the commodity exhibition task executed by the target store according to the change of the binding information comprises:
performing statistics on a ratio of a number of commodities in the commodity exhibition task for which information of binding with an electronic shelf label has changed within a first specified time period relative to a number of commodities in the commodity exhibition task; and
determining the ratio as the completion degree of the commodity exhibition task.

4. The method according to claim 2, wherein determining the completion degree of the commodity exhibition task executed by the target store according to the change of the binding information comprises:
performing statistics on time used to complete the change of information of binding between all commodities in the commodity exhibition task and the electronic shelf labels; and
determining the time used to complete the change of information of binding between all the commodities in the commodity exhibition task and the electronic shelf labels as the completion degree of the commodity exhibition task.

5. The method according to claim 1, wherein monitoring a change of information of binding between the commodity and the electronic shelf label in the target store comprises:
monitoring a change of a number of bindings between commodities in the commodity exhibition task and electronic shelf labels in the target store.

6. The method according to claim 1, wherein generating a commodity exhibition task and transmitting the commodity exhibition task to the target store comprises:
acquiring a commodity exhibition map of the target store;
determining commodity exhibition information of the target store according to the commodity exhibition map, wherein the commodity exhibition information comprises a layout of the electronic shelves in the target store, placement positions of commodities on the electronic shelves, and associations between the commodities and the electronic shelf labels;
generating the commodity exhibition task based on the commodity exhibition information; and
issuing the commodity exhibition task to a client of the target store, so that the client performs the commodity exhibition task by changing the information of binding between the commodity and the electronic shelf label.

7. The method according to claim 1, wherein the management server comprises a main management server and a branch management server, and generating a commodity exhibition task and transmitting the commodity exhibition task to the target store comprises:
generating, by the main management server, the commodity exhibition task and transmitting the commodity exhibition task to the branch management server, and receiving, by the branch management server, the commodity exhibition task and transmitting the commodity exhibition task to at least one client in the target store.

8. The method according to claim 1, wherein there are at least two target stores, and the method further comprises:
ranking completion degrees of the commodity exhibition tasks executed by the at least two target stores; and
transmitting a result of the ranking to all the target stores.

9. The method according to claim 1, wherein there are a plurality of commodity exhibition tasks, and the method further comprises:
acquiring a sales situation of a specified commodity commonly contained in the plurality of commodity exhibition tasks within a second specified time period after the plurality of commodity exhibition tasks are executed;
determining a placement position where the sales situation meets a preset condition as a specified placement position of the specified commodity; and
setting the specified placement position as the placement position of the specified commodity.

10. The method according to claim 9, further comprising: determining information of associated commodities to be placed around the specified commodity according to the specified placement position.

11. The method according to claim 1, further comprising:
acquiring information of best-selling commodities in the target store within a third specified time period; and
analyzing the information of the best-selling commodities to acquire high-value shelf information which comprises at least one of positions of electronic shelves where the best-selling commodities are located, placement positions of the best-selling commodities in the electronic shelves, or information of combination of commodities in the electronic shelves where the best-selling commodities are located.

12. The method according to claim 1, further comprising:
assigning an execution level to the commodity exhibition task according to an importance degree of the commodity exhibition task, wherein the execution level comprises one of at least first and second levels, a commodity exhibition task at the first level is a task which must be completed, and a commodity exhibition task at the second level is a task which is optionally completed.

13. A commodity exhibition management method executed by a client of a target store, the method comprising:
receiving a commodity exhibition task transmitted by a management server, wherein the commodity exhibition task instructs to place a commodity at a placement position in an electronic shelf of the target store, and at the placement position in the electronic shelf, an electronic shelf label is provided in order to be bound to a commodity placed at the placement position; and
executing the commodity exhibition task by changing information of binding between the commodity and an electronic shelf label associated therewith.

14. The method according to claim 13, wherein executing the commodity exhibition task by changing information of binding between the commodity and an electronic shelf label associated therewith comprises:
extracting a commodity exhibition instruction from the received commodity exhibition task, wherein the commodity exhibition instruction comprises a layout of the electronic shelf of the target store, placement position of the commodity on the electronic shelf, and association between the commodity and electronic shelf label;
providing a user with the commodity exhibition instruction, so that the user places the commodity at the placement position on the electronic shelf according to the commodity exhibition instruction; and
changing the information of binding between the commodity and the electronic shelf label associated therewith in response to the user's placement of the commodity, and transmitting change data of the information of binding to the management server.

15. A management server, comprising a memory and a processor, wherein the memory has stored therein instructions which, when executed by the processor, cause the processor to execute the method according to claim 1.

16. A client, comprising a memory and a processor, wherein the memory has stored therein instructions which, when executed by the processor, cause the processor to execute the method according to claim 13.

17. A commodity exhibition management system, comprising:
a management server configured to generate a commodity exhibition task and transmitting the commodity exhibition task to a target store, wherein the commodity exhibition task instructs to place a commodity at a placement position in an electronic shelf of the target store, and wherein at the placement position in the electronic shelf an electronic shelf label is provided in order to be bound to a commodity placed at the placement position; and determine a completion degree of the commodity exhibition task executed by the target store by monitoring a change of information of binding between the commodity and electronic shelf label in the target store; and
a client located in the target store and in communication with the management server, and configured to receive the commodity exhibition task from the management server, and execute the commodity exhibition task by changing information of binding between the commodity and an electronic shelf label associated therewith.

18. The system according to claim 16, further comprising:
a sensor located in the electronic shelf of the target store, and configured to acquire sales information of commodities placed in the electronic shelf and feed the sales information back to the management server.
